(19) United States
(12) Patent Application Publication
(10) Pub. No.: US 2007/0141196 A1
(43) Pub. Date: Jun. 21, 2007

(54) Apparatus For Forming A Through Opening In A Molded Part

(76) Inventor: Vince Ciccone, Kleinburg, ON (CA)

Correspondence Address: HODGSON RUSS LLP, ONE M & T PLAZA, SUITE 2000, BUFFALO, NY, 14203-2391, US

(21) Appl. No.: 11/561,475

(22) Filed: Nov. 20, 2006

Related U.S. Application Data
(60) Provisional application No. 60/737,966, filed on Nov. 18, 2005.

(51) Int. Cl. B29C 45/00

(52) U.S. Cl. 425/577; 425/DIG. 58; 425/542

(57) ABSTRACT

An apparatus for forming an opening or the like in an injection molded part formed in a molding cavity defined between core block and cavity block of a mold, the core and cavity blocks movable relative to each other between open and closed positions, the molding cavity defined between the cavity and core blocks in the closed position, the apparatus comprising an elongate segmented pin insertable in the mold, having axially aligned segments when the blocks are in the closed position, and the segments separable from each other as the mold opens, in the closed position the pin extending from an external portion of the mold to the molding cavity, the pin being actuatable by activation means to axially extend into the molding cavity so as to form an opening or the like in the molded part formed in the molding cavity. The elongate segmented pin comprising a first segment mounted on an external portion of the core block connected to activation means for axially extending the pin through the molding cavity, a second middle segment extending through a portion of the cavity block and a third lead segment which when in the closed position is extendable by the activation means through the molding cavity such that the lead end of the pin forms a through opening in a molded part formed in the molding cavity, the second and third segments staying with the cavity block and separating from the first segment as the core and cavity block move from the closed to the open position.

### FIELD OF THE INVENTION

This invention relates to injection molding machines, and in particular, to an apparatus for forming a through hole in a molded part during injection.

### BACKGROUND OF THE INVENTION

Injection-molded plastic containers typically have a bottom portion 300, a hollow body portion, a rim 302 portion marking the open end of the container, and a skirt portion 304, often in spaced relation to the rim portion and designed for various purposes, such as to reinforce the open end of the container and to provide for locking means (in relation to a specific lid). Typically, the skirt has at least a pair of holes for installation of a wire or plastic handle. The majority of such holes are round, but oval or open-ended holes (with the opening extending to the edge of the skirt, for use with plastic handles which typically are slid in place, as opposed to being pushed transversally into the hole) are also commonly used.

Injection molds of prior art are known to use collets (also known as segments) to mold the outer surface of the skirt and rim. In such cases, the holes for handles are made by handle inserts (also called ear inserts), such as shown in FIGS. 1 through 1C. Handle inserts are small inserts secured to the collets (generally two handle inserts, secured to two of the typical four collets). As the mold opens at the end of the injection cycle and the core and cavity sides separate from each other, the collets extend from the core side and radially away from each other to free the molded part, which is then ejected by mechanical or pneumatic means. The handle inserts retract together with the collets, freeing the skirt at the same time as the collets.

While such molds of prior art can produce quality parts, collets pose a variety of problems. For example, it is more complicated to machine a set of collets than a solid ring, due to the requirement to ensure precise matching at the contact surface of pairs of collets, to prevent flashing. The presence of collets in a mold requires appropriate extension and retraction means, to provide the necessary motion of collets. Also, guiding means for the motion of the collets are needed, to ensure that collets extend and retract equally and return to their proper locations without shifting (the quality and performance of the molded part are greatly influenced by the quality of the collets). Maintenance of collets is also more complicated, to ensure that such extend-return and guide means are cleaned and functional, and that sharp edges are maintained on the collets to prevent part flashing. Also, collets will always create witness lines on the outer surface of the molded part, where profiles of pairs of collets come in contact. For these functional and cosmetic reasons, it is often desirable to use solid rings instead of collets. Rings, however, have the limitation that they can only move axially, but not radially-outwardly during mold opening, as collets do, and for this reason, any undercut (such as the handle holes) requires a separate solution to release the grip on the molded container before ejection.

A second design of prior art (shown in FIGS. 2 through 2D) replaces the collets with a stripper ring (which is movable axially, but not radially) and uses a taper lock to push a handle pin in place for injection, creating the opening in the molded part. As can be seen in the FIGS. 2B and 2C, the closing of the mold activates the wedging action of the taper lock, and the pin is supported against injection pressures throughout the injection cycle by the closing force of the injection press. As the mold halves separate during mold opening, a compression spring acts to retract the pin and release its grip from the molded container. The spring continues to hold the pin retracted until the mold closes again.

A third design of prior art, shown in FIGS. 3 through 3E, also replaces the collets with a stripper ring (movable axially, but not radially). The openings in the molded part are made by pins extending from the outer surfaces of the mold, through the mold and shutting off against the wall of the handle portion of the cavity. Each pin is activated by a cylinder (pneumatic or hydraulic), mounted externally on the mold, the cylinder receiving signals to extend or retract the pin in timed relation to the mold cycles. Since this arrangement requires the pin to pass through both the core and the cavity sides, while attached to the cavity side (the cylinder is mounted onto an extension plate secured to the cavity block), a disadvantage of such a design is the necessity to slot the core block where the handle pins pass through. As can be seen in FIG. 3, the slotted portion (shown on the left side of the figure) corresponds to the taper lock (shown on the right side of the figure), which ensures the closing precision of the core and cavity halves for the injection cycle. Any slotting of the taper lock negatively influences its quality, and as such is undesirable.

### SUMMARY OF THE INVENTION

It is an object of the invention to provide an improved apparatus for producing a through hole in injection molded parts. The present invention achieves such a design by replacing a single long pin passing through both cavity and core halves with a multi-segmented pin, which separates into parts that can stay with either the core half or the cavity half, allowing unobstructed opening of the mold and part ejection as explained in detail below.

In accordance with an aspect of the invention there is provided, an apparatus for forming an opening or the like in an injection molded part formed in a molding cavity defined between core block and cavity block of a mold, said core and cavity blocks movable relative to each other between open and closed positions, said molding cavity defined between said cavity and core blocks in said closed position, said apparatus comprising: an elongate segmented pin insertable in said mold, having axially aligned segments when said blocks are in said closed position, and said segments separable from each other as said mold opens, in said closed position said pin extending from an external portion of said mold to said molding cavity, said pin being actuatable by activation means to axially extend into said molding cavity so as to form an opening or the like in the molded part formed in said molding cavity.

The elongate segmented pin may comprise a first segment mounted on an external portion of said core block connected to activation means for axially extending said pin through said molding cavity, a second middle segment extending through a portion of said cavity block and a third lead segment which when in said closed position is extendable by said activation means through said molding cavity such that said lead end of said pin forms a through opening in a molded part formed in said molding cavity, and at least said second segment staying with said cavity block and separating from said first segment as said core and cavity block move from said closed to said open position.

### BRIEF DESCRIPTION OF THE DRAWINGS

FIG. 1 is an exemplary vertical sectional view along the center of a mold of a first design of prior art, using collets and handle inserts, shown with the mold closed;

FIG. 1A is an exemplary vertical sectional view of the prior art mold of FIG. 1, shown with the mold open and with the collets extended to release the molded container;

FIG. 1B is an enlarged detail of a portion of FIG. 1, showing the handle insert, collet and cavity ring;

FIG. 1C is a side view detail of the portion shown in FIG. 1B;

FIG. 2 is an exemplary vertical sectional view along the center of a mold of a second design of prior art, using core rings and taper-lock activated handle pin, shown with the mold closed;

FIG. 2A is an exemplary vertical sectional view of the prior art mold of FIG. 2, shown with the mold open, the core rings extended and the handle pin retracted to release the molded container;

FIG. 2B is an enlarged detail of a portion of FIG. 2A, showing the handle pin area as the mold approaches the closed position;

FIG. 2C is an enlarged detail similar to that of FIG. 2B, but shown after completion of mold closing;

FIG. 2D is a side view detail of the handle pin area of FIG. 2C;

FIG. 3 is an exemplary vertical sectional view along the center of a mold of a third design of prior art, using stripper ring and a cylinder-activated handle pin, shown with the mold closed;

FIG. 3A is a detail of the handle pin area of FIG. 3, shown with the mold closed and pin extended to form the handle opening;

FIG. 3B is a side view detail of the handle pin area of FIG. 3A;

FIG. 3C is a detail similar to that of FIG. 3A, shown with the mold closed but with the handle pin retracted;

FIG. 3D is a detail similar to that of FIG. 3C, shown with the handle pin retracted as the mold starts to open;

FIG. 3E is a side view detail of the handle pin area of FIG. 3D;

FIG. 4 is an exemplary vertical sectional view along the center of a mold of an embodiment of the invention, shown with the mold in a closed position;

FIG. 4A is an enlarged detail view of a portion of the embodiment of FIG. 4, illustrating the segmented pin and shown with the mold closed and the pin extended to form the through opening in the molded part in the molding cavity;

FIG. 4B is an enlarged detail similar to that of FIG. 4A, shown with the mold closed but with the segmented pin retracted from the molding cavity;

FIG. 4C is an enlarged sectional view similar to that of FIG. 4B, shown with the segmented pin retracted as the mold starts to open, the stripper ring still in its pocket in the core block and the molded part still on the core block, with the first segment of the pin staying with the core half, while the other two segments staying with the cavity half,

FIG. 4D is an enlarged sectional view similar to that of FIG. 4C, shown with the stripper ring extended to release the molded part off the core block;

FIG. 5 is an enlarged sectional view of an alternate embodiment of the present invention, including handle inserts instead of cavity rings and exemplifying formation of an open-ended handle hole, shown with the mold closed and segmented pin extended;

FIG. 5A is a side view detail of the embodiment of FIG. 5;

FIG. 5B is a detail similar to that of FIG. 5, but shown with the segmented pin retracted as the mold starts to open, the molded part still on the core block illustrating one segment of the segmented pin staying with the core half, while two segments staying with the cavity half, and

FIG. 5C is a side view detail of the segmented pin area of FIG. 5B.

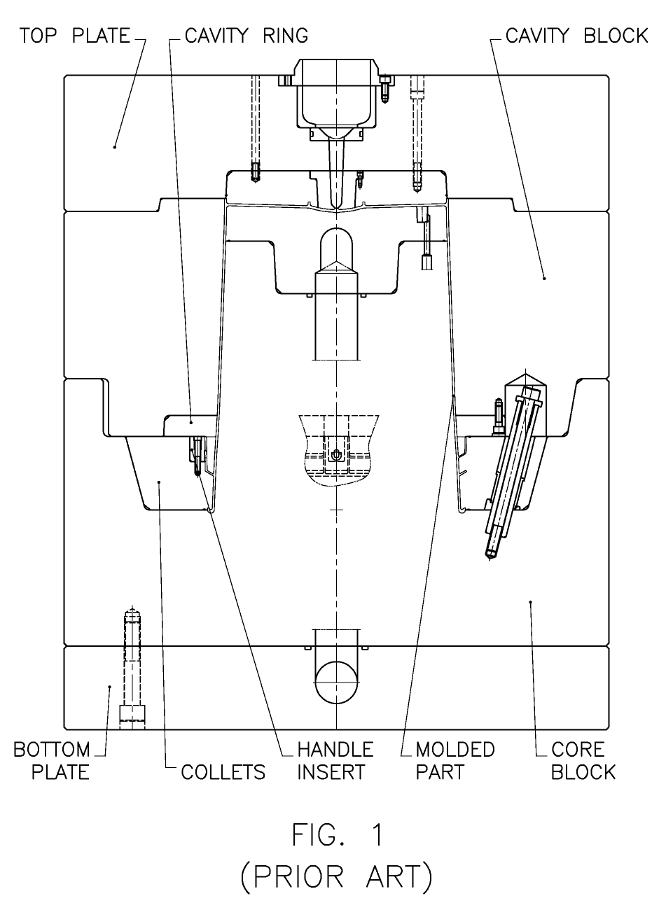

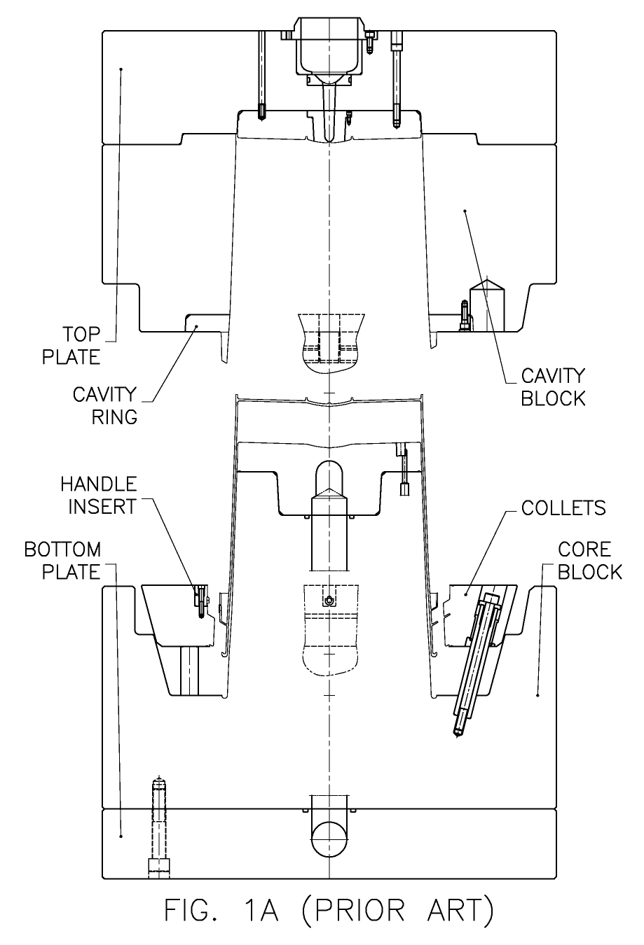

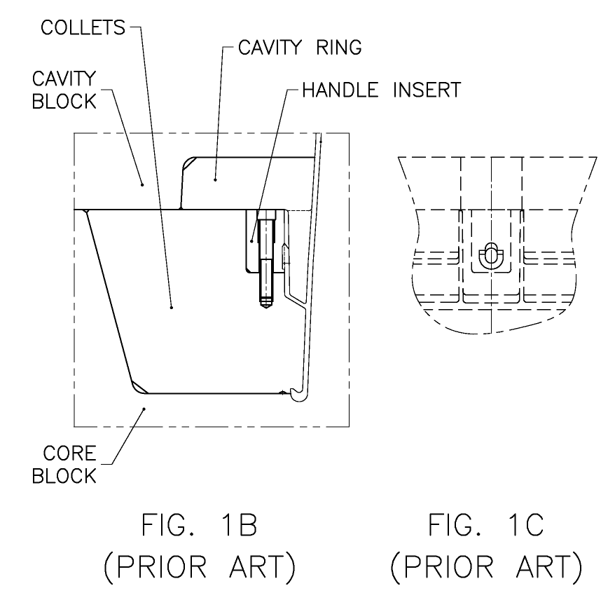

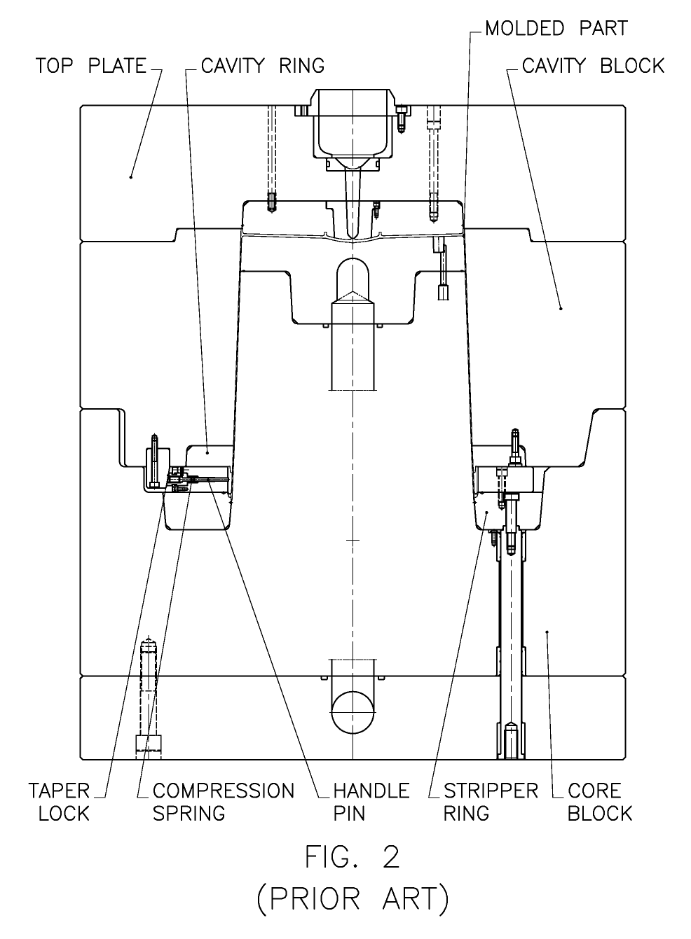

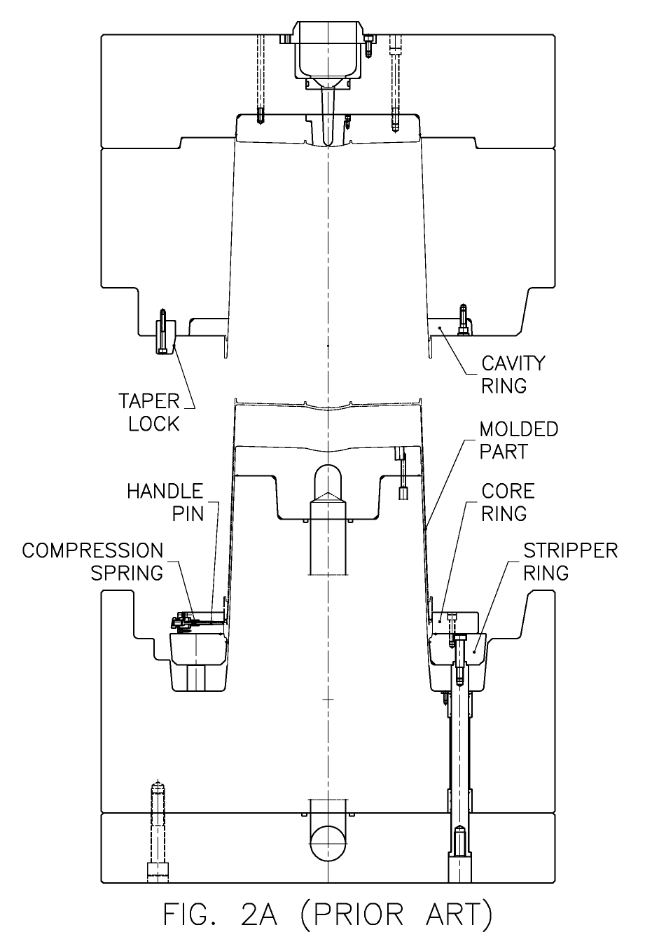

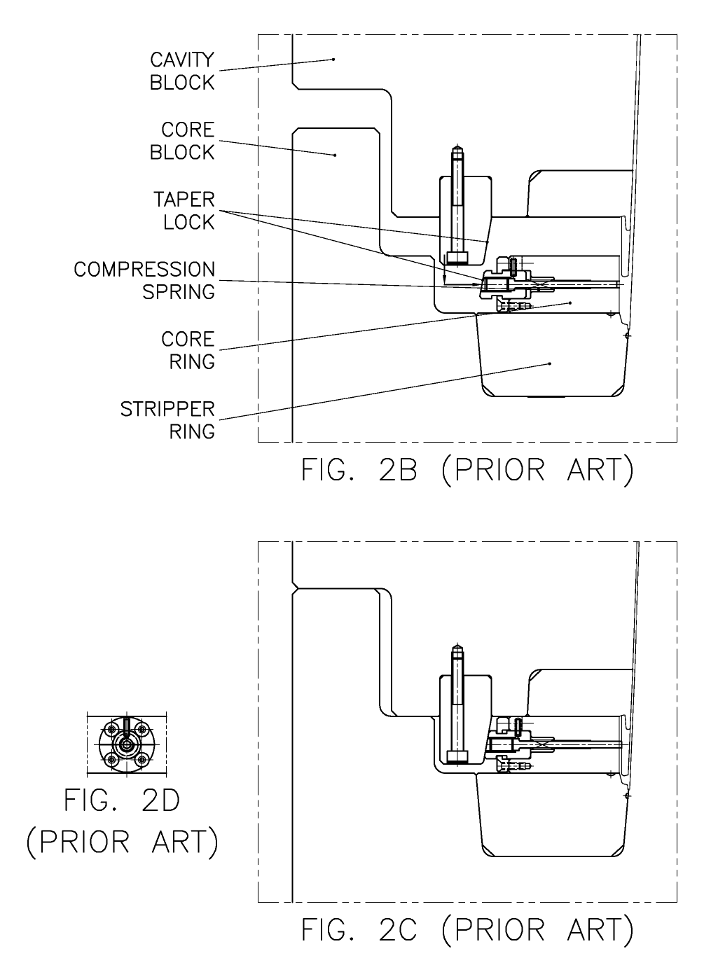

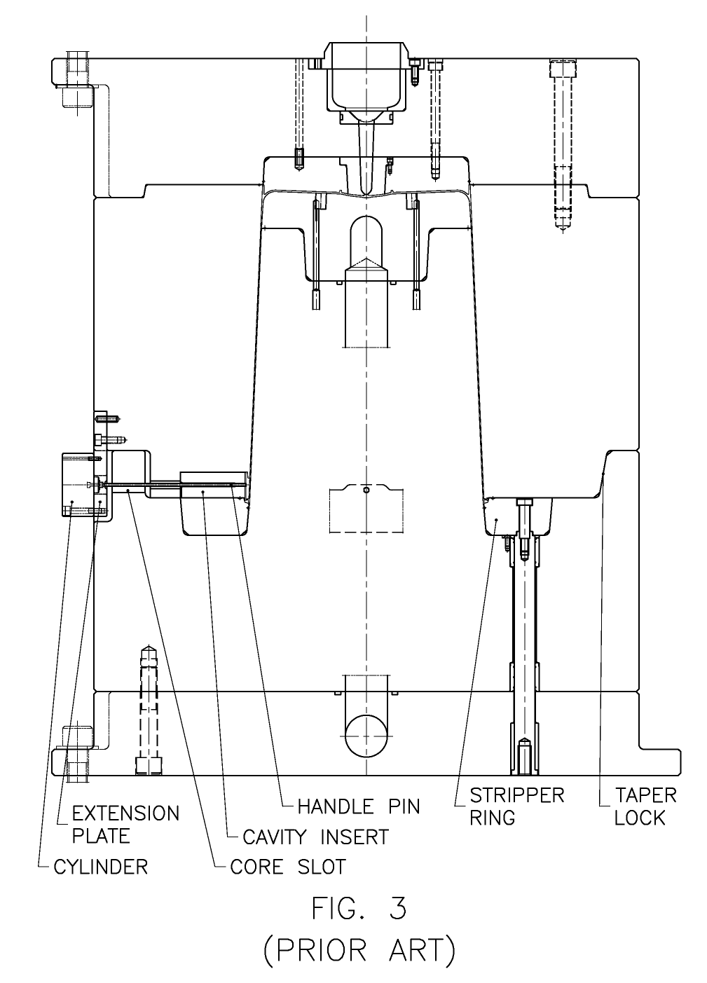

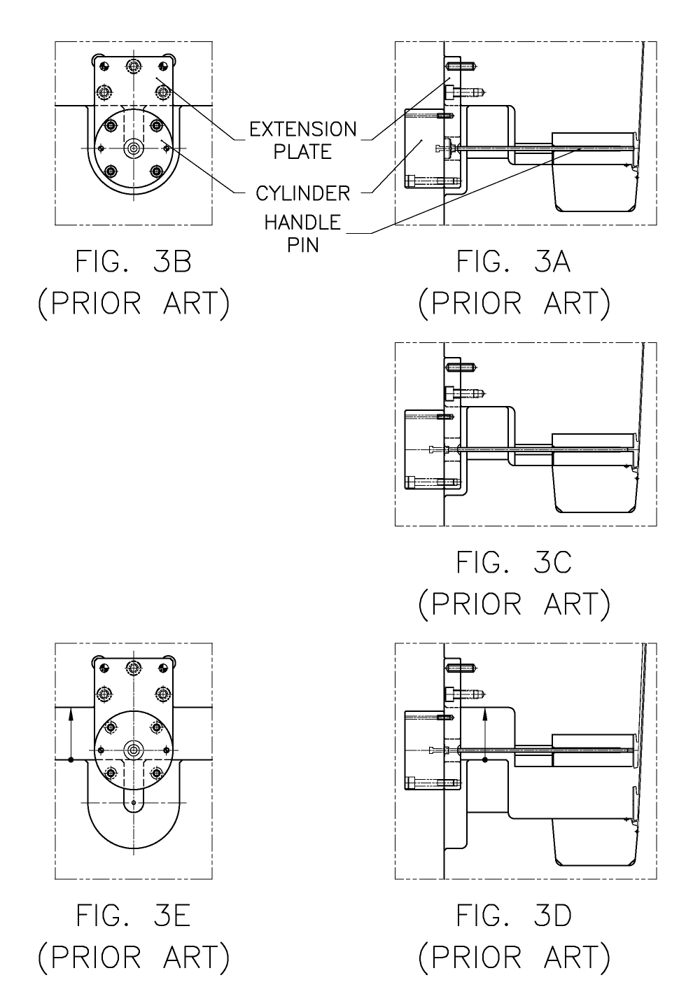

Throughout the drawings, similar reference numerals are used in different figures to denote similar components.

### DETAILED DESCRIPTION OF EXAMPLE EMBODIMENTS OF THE INVENTION

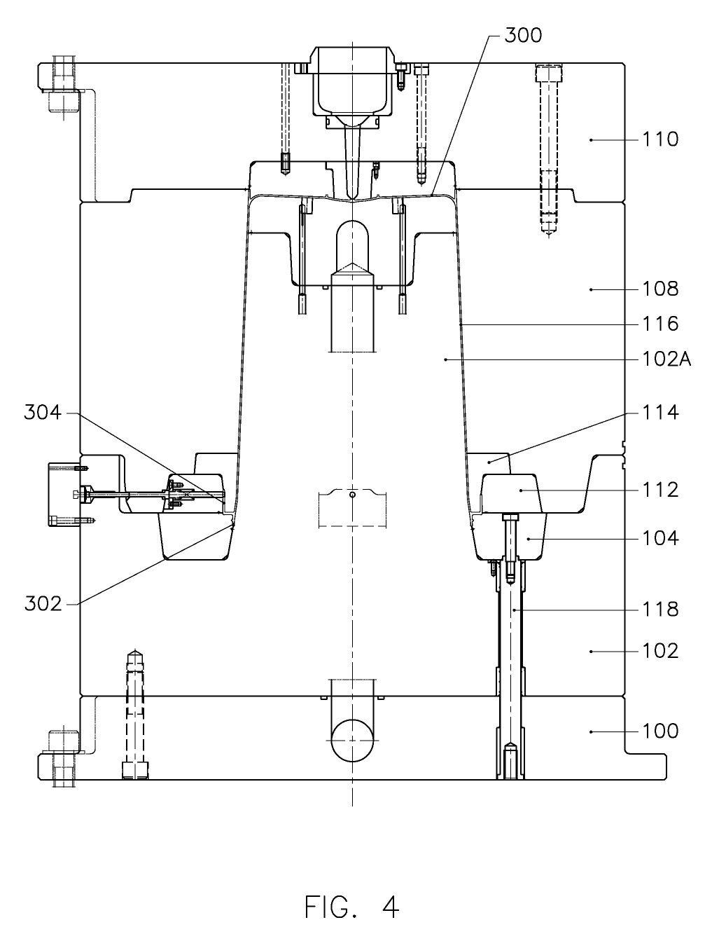

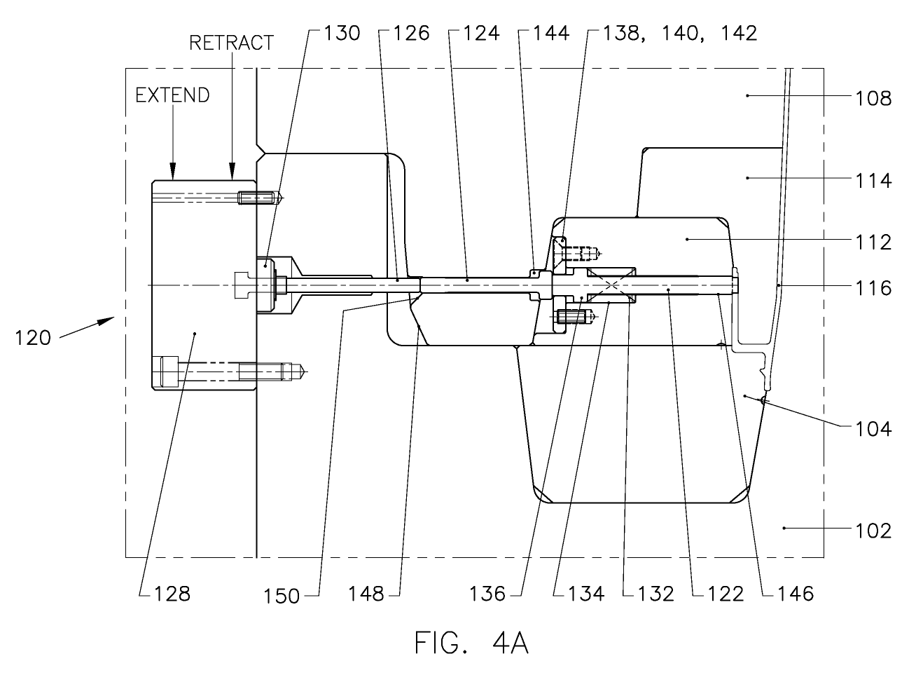

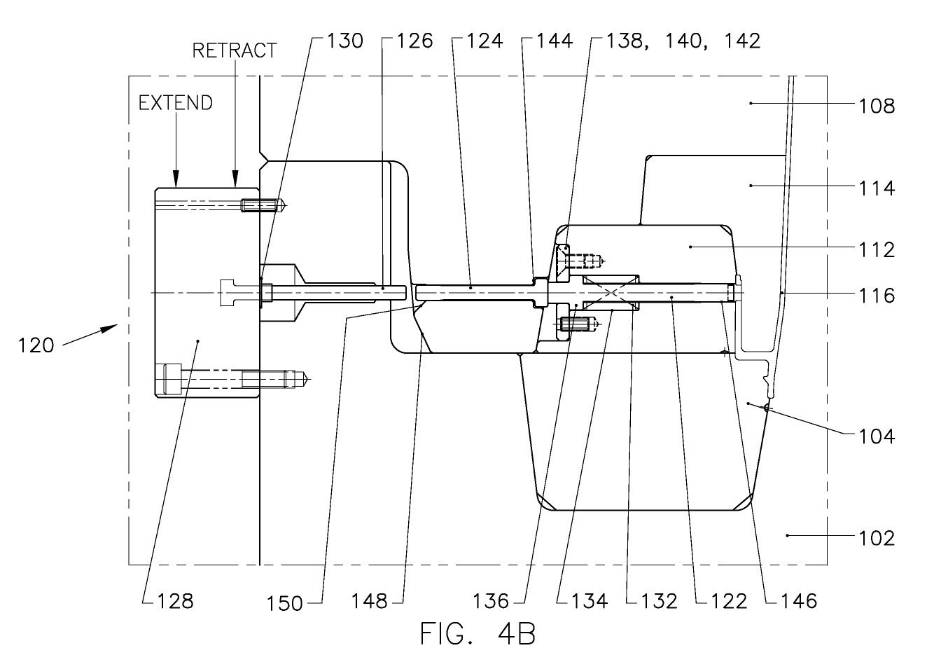

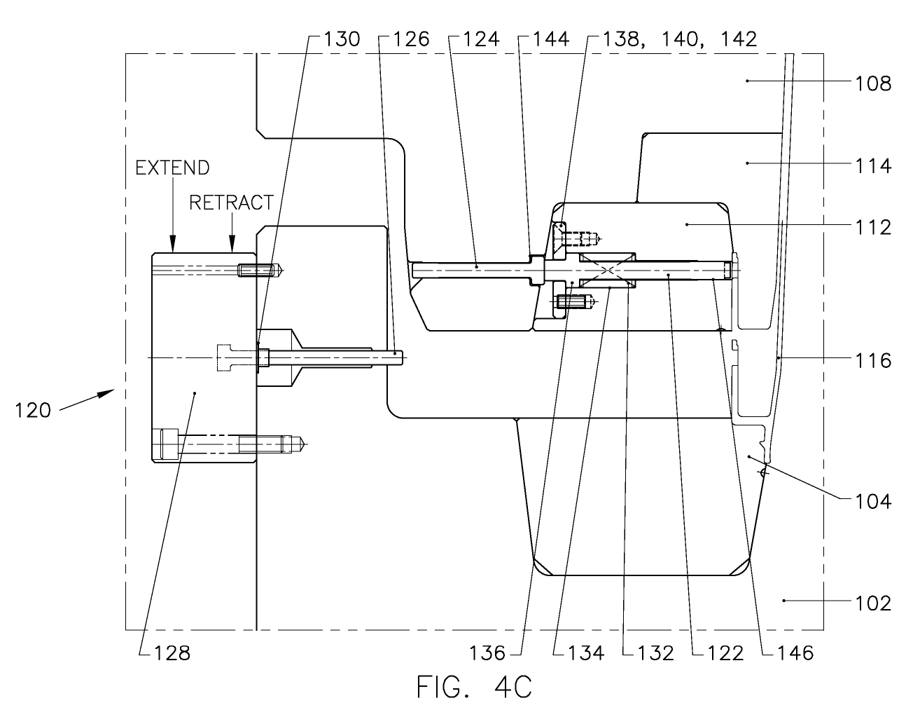

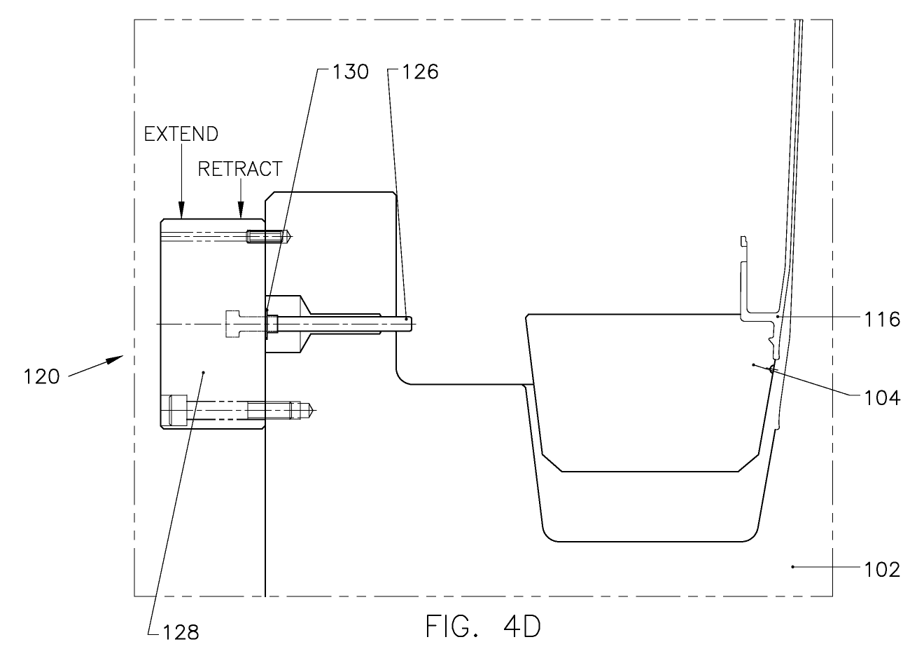

With reference to FIGS. 4 through 4D, the following is a detailed description of an exemplary embodiment of the invention, which illustrates how the present invention provides a system that allows release of a pin for creating a through opening in an injection molded part during the opening cycle of the mold, and also how the pin separates into segments that can stay with either the core half or the cavity half, allowing unobstructed opening of the mold and part ejection. The drawings show an embodiment of the invention used with a single-cavity container mold. It should be understood that the present invention might be utilized with single cavity lid molds or other molded parts, with single-face multiple cavitation systems and also with stack mold systems, for container molds, lid molds and other molded parts.

With reference to FIG. 4, the mold comprises a bottom plate 100, core block 102, core ring (also referred to as stripper ring) 104, cavity block 108, top plate 110, and cavity rings 112 and 1 14. The stripper ring 104 is activated to extend and retract (to release the molded part 116 off the core boss 102A) by pneumatic/hydraulic or mechanical means 118 (as shown). The cavity rings 112 and 114 are both secured to the cavity block 108, and stay on the cavity block during the mold opening stage. Typically, air functions (such as air vents, air valves and air jets) aid in breaking off the contact between the molded part 116 and the mold components and blow the molded part off the core boss. In the embodiment shown, air valves (air poppets) on the core (and although not shown commonly also on the cavity side), placed at the bottom of the container, and vents around the inside (core side) and the outside (cavity side) of the molded part separate it from the core and the cavity, while air jets at the rim (not shown) push the container off the core boss 102A.

An aspect of the present invention is illustrated by the design of the bail lug, otherwise referred to herein as a multisegmented pin for forming a through opening in a molded part, such as the handle hole in a container skirt. As seen more clearly in FIG. 4A, the multisegmented pin assembly 120 comprises a multisegmented pin formed of: a first pin segment 126, a second intermediate segment 124, and third lead segment 122 which forms the skirt opening. First pin segment is connected to activation means, which in this embodiment is an activating cylinder 128, pneumatic or hydraulic, mounted externally on the core block 102. The separation of the pin in three segments during mold opening allows the cylinder (complete with end pin 126) to stay attached to the core block, while the other two parts of the pin stay with the cavity side when the mold opens. In the closed position, segments are axially aligned.

The first end pin segment 126 is in fixed and rigid connection to the piston 130 of cylinder 128, such that the extension and retraction motions of piston 130, as signaled by the mold, are directly transmitted to end pin 126. When the mold is in closed position, piston 130 extends end pin 126, which in turn pushes intermediate pin segment 124 and lead pin segment 122 towards the injection cavity, until the latter shuts-off on the cavity ring 114 (as shown in FIG. 4A). The stroke of piston 130 is selected to allow sufficient retraction of the end pin 126 as not to impede with the separation of mold halves.

In the embodiment shown, biasing means, such as for example spring 132, located in a pocket 134 in cavity ring 112, is compressed between bottom of pocket 134 and a flange portion 136 of the lead pin segment 122. As soon as piston 130 of cylinder 128 retracts, spring 132 activates lead pin segment 122 (which in turn pushes intermediate pin 124) to retract as shown in FIG. 4B. A cover plate 138, secured with screws 140 and located with dowels 142 in reference to cavity ring 112, acts as a limiter for the retraction of the lead pin segment 122. Similarly, bottom of pocket 144 in cavity block 108 acts as limiter for the motion of intermediate pin segment 124. When first end pin segment 126 is retracted by piston 130, and pins 122 and 124 are pushed by spring 132, the mold can open (FIG. 4C) and the molded part 116 can be ejected free of obstructions (FIG. 4D).

In the embodiment shown, cavity ring 112 guides the motion of the lead pin segment 122, both at its front end (internal end) and at the back (external) end. Cylindrical portion 146 guides the front end of the lead pin segment, while pocket 134 guides the flange portion 136 at the back end of the lead pin segment 122.

The placement of cover plate 138 and the depth of pocket 144 are calculated to allow sufficient stroke of the lead pin segment 122 and intermediate pin segment 124, such that lead pin segment 122 is able to retract fully from the molded part 1 16. Consequently, the stroke of cylinder 128 must be equal to or larger than the stroke of lead pin segment 122 and intermediate pin segment 124, such that end pin 126 does not impede in any way the retraction of the lead pin segment 122 and intermediate pin 124.

In the embodiment shown an additional safety feature is provided, comprising two tapered surfaces 148 and 150 of the cavity block which are positioned to urge retraction of the first pin segment during mold opening and closing, respectively. Such surfaces 148, 150 are included to prevent against damage of cavity block 108 and of first end pin segment 126. For example, in a malfunction condition, such as the situation where piston 130 of cylinder 128 fails to retract before mold opening (leaving a portion of end pin segment 126 in the extended position), as the mold halves start to separate, tapered surface 150 will act onto the rounded end edge of the end pin segment 126 and as the mold opens, mechanically urge it to retract sufficiently to allow mold opening. If end pin segment 126 is extended while the mold is in an open position, as the mold closes, the other tapered surface, 148, will act onto the end of first end pin segment and urge it to retract sufficiently to allow the mold to close. The corner between the two tapered surfaces 148 and 150 is preferably rounded, to allow the end pin segment to slide over easily.

Cylinder 128 preferably offers some means of fine adjustment of the amount of extension of end pin segment 126, to ensure appropriate shut-off at the lead end segment within the molding cavity. Such fine adjustment could be, for example, a fine thread engagement of a locating sleeve (not shown) into piston 130, with an additional threaded insert to lock the sleeve in position (or any other known fine adjustment). Such a system would allow easy fine tuning and subsequent adjustments of the mutisegmented pin system while the mold is in the machine, reducing downtime considerably.

The present invention can be used with various diameters of pins, depending on the required size of handle hole. The design is not limited to round (cylindrical) pins (and handle holes), but could make use of other shapes, such as oval or open-ended holes (as presented next). Although the present invention illustrates a pin comprising three segments, the invention herein contemplates more or less segments, if desired.

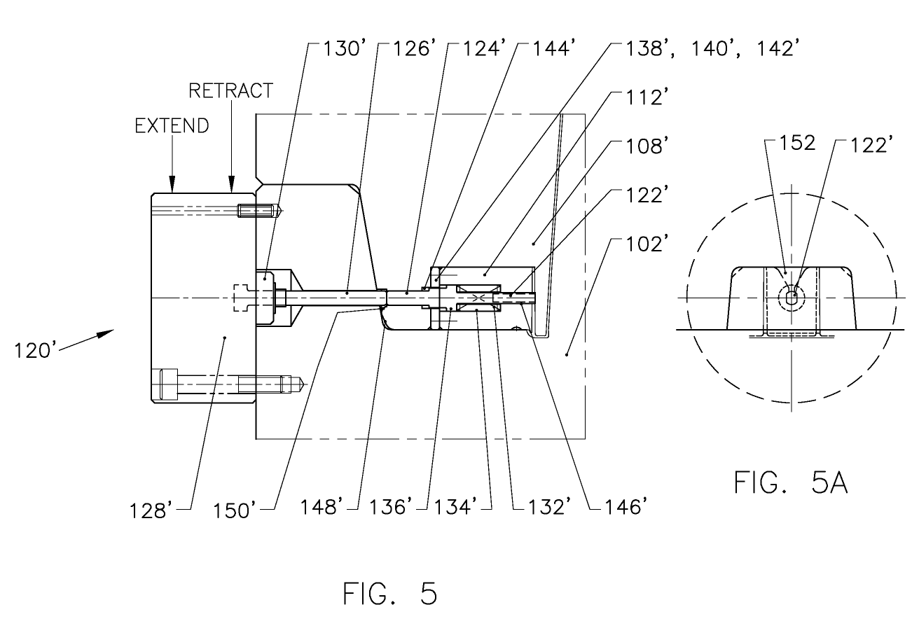

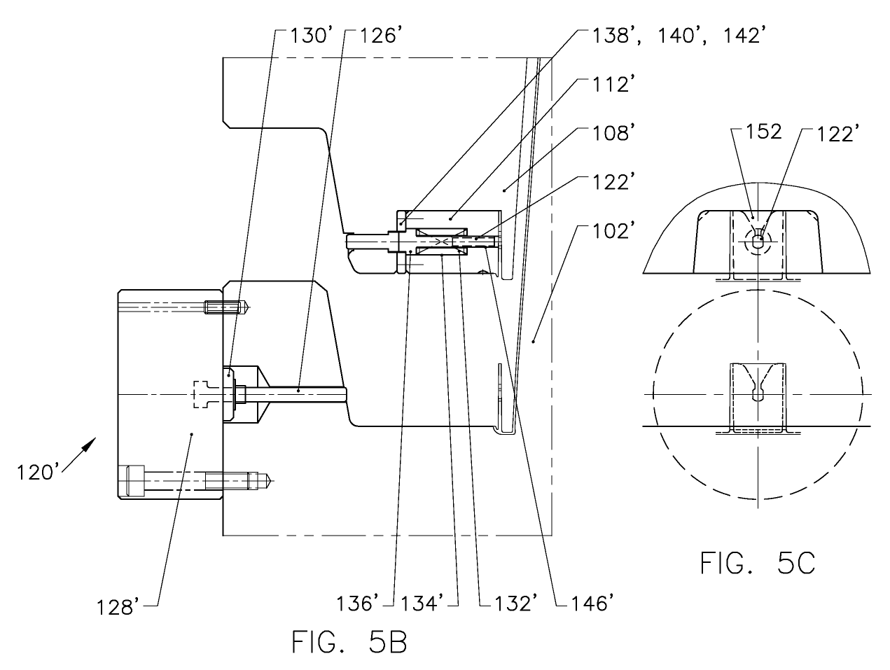

FIG. 5 through 5C present an adaptation of the preferred embodiment, which replaces the cavity rings with individual handle inserts 112′ (one handle insert for multisegmented pin) attached to the cavity block 108′ and creates open-ended handle holes. The v-portion 152 creating the open end of the handle hole is provided by the handle insert 112′. At the end of the injection cycle, the cylinder 128′ retracts the end pin segment 126′, while the spring 132′ retracts the lead pin segment 122′ (which in turn pushes intermediate pin segment 124′), removing any interference of undercuts and allowing the mold to open. After ejection of the molded part, the mold closes again and the cylinder activates the multisegmented pin to extend towards the injection cavity. This design offers the same advantages of the previous embodiment: double-guidance for multisegmented pin (portion 146′ at bail end and contact between flange portion 136′ of lead pin segment 122′ and pocket 134′), double-taper (surfaces 148′ and 150′) with radius to prevent damage in case of cylinder malfunction causing unwanted extension of the first end segment 126′, stroke limiters (cover plate 138′, secured with screws 140′ and located with dowels 142″, neither shown, for multisegmented pin 122′; bottom of pocket 144′ of cavity 108′ for intermediate pin 124′) and separation of pin into three segments (122′, 124′ and 126′) to allow opening free of obstructions.

A bail lug system such as shown in these two embodiments need not be limited to handle holes for plastic containers, but is envisioned for any application requiring molding of orifices in an injected part, if space allows provision of such a construction.

As will be apparent to those skilled in the art in the light of the foregoing disclosure, many alterations and modifications of the shown design are possible in the practice of this invention, without departing from the spirit or scope thereof.

1. An apparatus for forming an opening or the like in an injection molded part formed in a molding cavity defined between core block and cavity block of a mold, said core and cavity blocks movable relative to each other between open and closed positions, said molding cavity defined between said cavity and core blocks in said closed position, said apparatus comprising: an elongate segmented pin insertable in said mold, having axially aligned segments when said blocks are in said closed position, and said segments separable from each other as said mold opens, in said closed position said pin extending from an external portion of said mold to said molding cavity, said pin being actuatable by activation means to axially extend into said molding cavity so as to form an opening or the like in the molded part formed in said molding cavity.

2. An apparatus as recited in claim 1 wherein the elongate segmented pin comprising a first segment mounted on an external portion of said core block connected to activation means for axially extending said pin through said molding cavity, a second middle segment extending through a portion of said cavity block and a third lead segment which when in said closed position is extendable by said activation means through said molding cavity such that said lead end of said pin forms a through opening in a molded part formed in said molding cavity, and at least said second segment staying with said cavity block and separating from said first segment as said core and cavity block move from said closed to said open position.

3. An apparatus as recited in claim 2 wherein said core block comprises an external portion and a central core boss and said molded part is a container formed in part between said cavity block and core boss, said container having a bottom portion, a perimetral side wall extending upwardly from the bottom portion, a rim marking the open end of the container and an outer skirt portion extending downwardly around said rim in spaced relation thereto, said through opening being formed in said skirt of said container, and said third lead segment staying with said cavity block during opening of the mold plates.

4. An apparatus as recited in claim 3 wherein said cavity block further includes a cavity ring mounted to said cavity block, extending around said core boss, defining in part said molded part, said through opening being formed in said skirt of said container, said third lead segment of said pin extending through said cavity ring, and staying with said cavity ring during opening of the mold blocks.

5. An apparatus as recited in claim 3 wherein a stripper ring extends around said core boss, and forms in part the rim and skirt portion of the container, said stripper ring being activatable by pneumatic or mechanical means to extend towards said cavity side after mold opening to push the molded part off the core boss.

6. An apparatus as recited in claim 4 wherein a stripper ring extends around said core boss, and forms in part the rim and skirt portion of the container, said stripper ring being activatable by pneumatic or mechanical means to extend towards said cavity side after mold opening to push the molded part off the core boss, the cavity ring being secured to the cavity block, and in said closed position, said third lead segment extends by said activation means through said cavity ring into said molding chamber to form the through opening in said molded part.

7. Apparatus as recited in claim 5 wherein said activation means is a piston extendable from a cylinder mounted externally on said core block, said piston attached to said first pin segment, whereby in said closed position, said piston is extendable and retractable from said cylinder such that said piston extends said first segment of the pin to push said second intermediate segment which pushes said third lead segment into said molding cavity to form said through opening in said molded part.

8. Apparatus as recited in claim 7 wherein biasing means is located in a pocket in said cavity ring to bias the lead pin segment to retract from the molding cavity.

9. Apparatus as recited in claim 8 wherein biasing means is a spring compressed between a bottom portion of said pocket and a flange portion of the third lead segment of the pin, whereby as said piston retracts said first pin segment, said spring activates said lead segment of said pin to retract from said molding cavity, which in turn engages the second intermediate pin segment to retract.

10. Apparatus as recited in claim 9 wherein a cover plate located externally adjacent said cavity ring acts as a limiter for the retraction of the lead pin segment from said cavity ring, and a bottom portion of a pocket in said cavity block acts as limiter for the retraction of the intermediate second pin segment, whereby when said first pin segment is retracted by actuation means and second and third pin segments are pushed by said spring to retract, respective segments are positioned and aligned such that the mold blocks may be moved to said open position, and subsequently the molded part may be ejected by activation of the stripper ring.

11. Apparatus as recited in claim 10 wherein the pocket and cover plates are formed to allow sufficient retraction towards said external portion of the core block such that said lead pin segment may retract fully from the molding cavity.

12. Apparatus as recited in claim 10 wherein said cavity block includes first and second tapered lead surfaces, whereby in a malfunction condition where activation means does not fully retract said first pin segment, as the mold blocks start to separate during opening, said first tapered surface acts on said first pin segment and mechanically urges it to retract sufficiently to allow the mold to open, and as the mold blocks close, said second tapered surface acts on the first pin segment to urge it to retract sufficiently to allow the mold to close.

13. Apparatus as recited in claim 12 wherein a corner formed between the first and second tapered surfaces is rounded, thereby allowing the first pin segment to slide thereover.

14. Apparatus as recited in claim 3 wherein said cavity block further includes a handle insert mounted to said cavity block defining in part a handle portion of said skirt of said molded part, said through opening being formed in said handle portion of said molded part.

15. Apparatus as recited in claim 14 wherein said through opening is an open ended handle hole.

16. Apparatus as recited in claim 9 wherein in a malfunction condition where activation means does not fully retract said first pin segment, said biasing means activates said lead segment of said pin to retract from said molding cavity, which in turn engages the second intermediate pin segment which in turn engages said first pin segment to retract toward said external portion of the core block.

17. Apparatus as recited in claim 2 wherein said activation means is a piston extendable from a cylinder mounted externally on said core block, said piston attached to said first pin segment, whereby in said closed position, said piston is extendable and retractable from said cylinder such that said piston extends said first segment of the pin to push said second intermediate segment which pushes said third lead segment into said molding cavity to form said through opening in said molded part, and as said piston retracts said first pin segment, biasing means acts to retract said lead segment from the molding cavity.

18. Apparatus as recited in claim 7 wherein said activation means includes fine adjustment means to adjust the amount of extension of said end pin segment within the molding cavity to ensure appropriate positioning of said segmented pin for forming said through opening.

19. Apparatus as recited in claim 18 wherein said fine adjustment means comprises adjustable fine threaded engagement of said piston and cylinder with a locating sleeve on said cavity block, including an additional threaded insert to lock the sleeve in position.
